(19) United States
(12) Patent Application Publication
(10) Pub. No.: US 2001/0013958 A1
(43) Pub. Date: Aug. 16, 2001

(54) IMAGE SCANNING METHOD APPLIED TO AN IMAGE SCANNING DEVICE

(76) Inventors: JENN-TSAIR TSAI, HSINCHU (TW); BILL CHEN, HSINCHU (TW)

Correspondence Address: LAFF WHITESEL CONTE AND SARET, 401 NORTH MICHIGAN AVENUE, CHICAGO, IL, 606114221

(21) Appl. No.: 09/144,704

(22) Filed: Sep. 1, 1998

(51) Int. Cl. H04N 1/04

(52) U.S. Cl. 358/486

(57) ABSTRACT

An image scanning method applied to an image scanning device is disclosed. The method includes the steps of (a) detecting a first boundary of the object and a secondary boundary opposite to said first boundary of the object, (b) executing a color calibration of each pixel disposed between the first boundary and the second boundary of the object, and (c) scanning the object between the first boundary and the second boundary of the object. The method of the present invention can reduce the length of the image scanning device, and only needs to calibrate the pixels and transfer the digital singal within the area of the scanned object so that it can achieve the purpose of saving time in the calibrating and scanning process.

### FIELD OF THE INVENTION

The present invention is related to a method for scanning an object, and more particularly to an image scanning method applied to an image scanning device.

### BACKGROUND OF THE INVENTION

Please refer to FIG. 1 showing a schematic diagram of a general image scanning device. As shown in FIG. 1, the image-picking device 11 generates a digital singal representative of the image of the scanned paper 15. A driving device 12 drives the image-picking device 11 to scan the scanned paper 15. The scanning flat 13 has a scanning window for placing thereon a scanned paper 15 to be scanned and a color calibrating piece 14, which is in standard black or in standard white, mounted on the scanning flat 13 for calibrating the image-picking device 11. The color calibration is executed by assigning a gray scale value of 255 to the pixel when the calibrating piece 14 is in standard white, but assigning a gray scale vale of 0 to the pixel when the calibrating piece 14 is in standard black. The standard white and standard black are representative of the response of the bright and the dark in color calibration respectively.

Please refer to FIG. 2 showing the flowchart of an image scanning method of a general image scanning device. The image-picking device 11 moves from the initial line 16 to the color calibrating piece 14 to execute the color calibration, and then it moves forward to prescan the scanned paper 15 placed on the scanning flat 13. The prescanning image of the scanned paper 15 determines the width W and the length L of the scanned paper 15. In accordance with the width W and the length L, the image-picking device 11 scan the scanned paper 15. After completely scanning the scanned paper 15, the image-picking device 11 moves back to the initial line 16 to wait for the next motion.

As we know, the electric products have a tendency to become smaller in volume for a convenient portability. The above-described image scanning device has a defect of large volume because it must have another space for mounting a color calibrating piece 14 on the scanning flat 13 and placing an image-picking device 11 on the initial line 16. As shown in FIG. 2, the method has a defect of wasting time in prescanning the scanned paper 15. Therefore, it is desirable to develop a method to solve the problems encountered by prior arts.

### SUMMARY OF THE INVENTION

An object of the present invention is to provide an image scanning method for an image scanning device. The image scanning device includes a scanning flat having a scanning window for placing thereon an object to be scanned and a color calibrating piece mounted on the scanning flat for calibrating the image-picking device. The image-picking device is placed on one end of the scanned object near the color calibrating piece before scanning to generate a digital signal representative of the image of the scanned object. The driving device is connected to said image-picking device to drive it to scan the scanned object and move back to the initial position when finishing the scanning process.

In accordance with the present invention, a method for scanning an object includes the steps of (a) detecting a first boundary of the object and a secondary boundary opposite to the first boundary of the object, (b) executing a color calibration of each pixel disposed between the first boundary and the second boundary of the object, and (c) scanning the object between the first boundary and the second boundary.

In accordance with another aspect of the present invention, after the step (a), the step futher includes (a1) forming a contrast between a background and the object, and (a2) finding out where the contrast is formed.

In accordance with another aspect of the present invention, the first boundary and the second boundary are left boundary and right boundary respectively.

In accordance with another aspect of the present invention, the step (a) is executed by an image-picking device.

In accordance with another aspect of the present invention, the step (b) is executed by scanning a calibrating piece.

In accordance with another aspect of the present invention, the step (b) is executed by assigning a gray scale value of 0 to the pixel when the calibrating piece is in standard black.

In accordance with another aspect of the present invention, the step (b) is executed by assigning a gray scale value of 255 to the pixel when the calibrating piece is in standard white.

In accordance with another aspect of the present invention, after the step (c), the method futher includes a step of (d) generating a digital signal representative of a portion of the scanned object between the first boundary and the second boundary.

In accordance with another aspect of the present invention, the step (d) is executed by a charge coupled device.

In accordance with another aspect of the present invention, after the step (d), the method further includes a step of (e) detecting a lower boundary of the object.

In accordance with another aspect of the present invention, after the step (e), the method further includes a step of (f) initializing the image-picking device when the lower boundary of the object is detected.

The present invention may best be understood through the following description with reference to the accompanying drawings, in which:

### BRIEF DESCRIPTION OF THE DRAWINGS

FIG. 1 is a schematic diagram showing a general image scanning device.

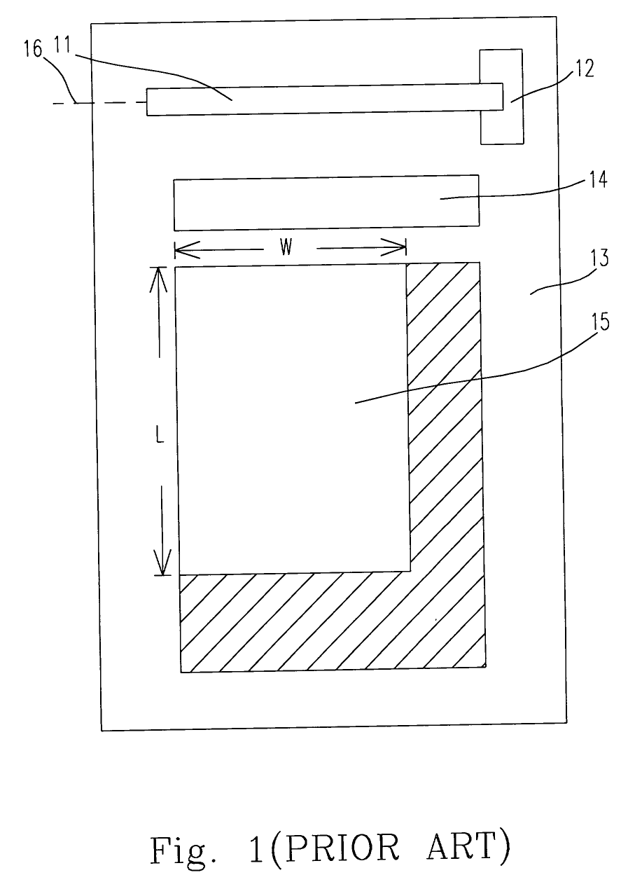

FIG. 2 is a flowchart showing the image scanning method of a general image scanning device.

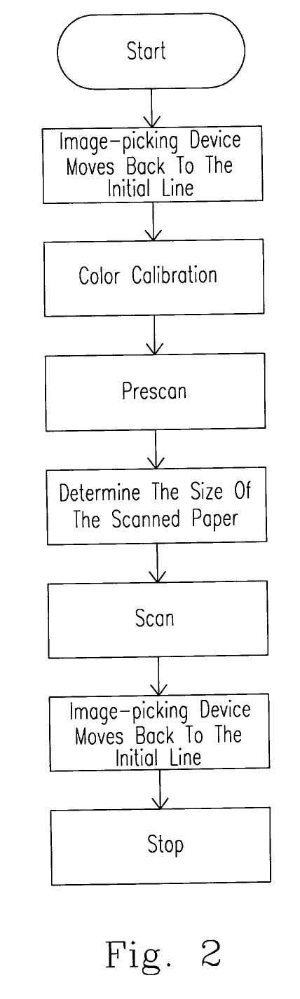

FIG. 3 is a schematic diagram showing a preferred embodiment of the image scanning device of the present invention.

FIG. 4 is a flowchart showing the image scanning method for a preferred embodiment of the present invention.

### DETAILED DESCRIPTION OF THE PREFERRED EMBODIMENTS

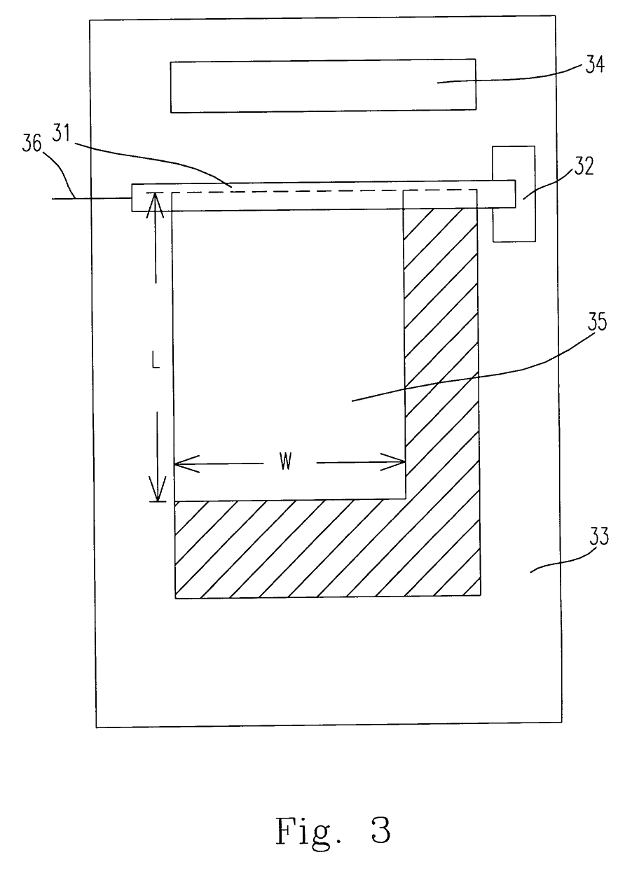

Please refer to FIG. 3 showing the preferred embodiment of the present invention. The image-picking device 31 generates a digital singal representative of the image of the scanned paper 35. A driving device 32 drives the image-picking device 31 to scan the scanned paper 35. The scanning flat 33 has a scanning window for placing thereon a scanned paper 35 to be scanned and a color calibrating piece 34, which is in standard black or in standard white, mounted on the scanning flat 33 for calibrating the image-picking device 31. The initial line 36 on which the image-picking device 31 places before executing the scanning process can be set on the position between the scanned paper 35 and the color calibrating piece 34 to reduce the length of the image scanning device. However, the best one is to set the initial line 36 on one end of the scanned paper 35 near the color calibrating piece 34.

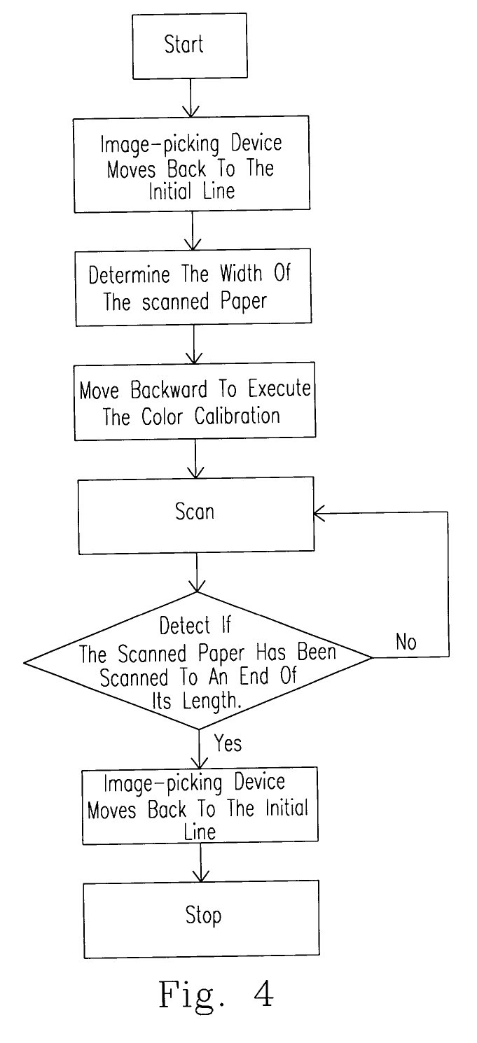

Please refer to FIG. 4 showing the flowchart of the image scanning method of a preferred embodiment of the present invention. The initial line 36 on which the image-picking device 31 places before executing the scanning process is set on one end of the scanned paper 35 near the color calibrating piece 34 so that the image-picking device 31 can immediately detect the boundary of the scanned paper 35 to obtain the width W of the scanned paper 35. Taking a reflection-type scanner for example, the color calibration is executed by assigning a contrast between the background and the scanned paper 35. In the reflective scanner, the image-picking device 31 executes a linear scanning process to determine the width W of the scanned paper 35 in accordance with the difference between the brightness of the background and the scanned paper 35. Certainly, the present invention can also be used in a transmission-type scanner. It only needs to set a difference in transmittance between the background and the scanned paper 35.

After detecting the width W of the scanned paper 35, the image-picking device 31 moves backward from initial line 36 to the color calibrating piece 34 to execute the color calibration. The theory and motion has been described in the background of this specification. In accordance with the width W of the scanned paper 35, the image-picking device 31 executes a color calibration of each pixel disposed between the right boundary and the left boundary. It does not execute a color calibration of the pixel over the boundary of the scanned paper 35 so that it can save much time in calibration.

After finishing color calibration, it moves forward from the color calibrating piece 34 to scan the scanned paper 35 placed on the scanning flat 33. In accordance with the width W of the scanned paper 35, the image-picking device 31 executes the scanning process and generates a digital singal representative of the image of the scanned paper 35 within the boundary of the scanned paper 35 but not over the boundary of the scanned paper 35. It can save much time in the scanning process.

When scanning the scanned paper, the image-picking device 31 detects if it has been scanned to an end of the length L of the scanned paper 35 (it is easy to detect if the image-picking device 31 scans outside the length L of the scanned paper 35 because there is a contrast between the background and the scanned paper 35). If not, the image-picking device 31 scans continuously. After finishing the scanning process, the image-picking device 31 moves back to the initial line 36 to wait for the next motion.

In accordance with the above-described method, the method of the present invention is to set the initial line 36 where the image-picking device 31 places before scanning on the scanned paper 35 near the color cailbrating piece 34. It can not only reduce the length of the image scanning device, but also detect the width W of the scanned paper 35 without prescanning. The method of the present invention only needs to calibrate the pixels and transfer the digital singal within the area of the scanned paper 35 so that it can achieve the purpose of saving time in the scanning process.

The above embodiments can be modified by any skillful person in the art without departing the spirit and scope of the accompanying claims.

What is claimed is:

1. A method for scanning an object comprising steps of:
(a) detecting a first boundary of said object and a secondary boundary opposite to said first boundary of said object;
(b) executing a color calibration of each pixel disposed between said first boundary and said second boundary of said object; and
(c) scanning said object between said first boundary and said second boundary of said object.

2. The method accroding to claim 1 wherein said step (a) futher comprises a step of:
(a1) forming a contrast between a background and said object; and
(a2) finding out where said contrast is formed.

3. The method accroding to claim 1 wherein said first boundary and said second boundary are left boundary and right boundary, respectively.

4. The method accroding to claim 1 wherein said step (a) is executed by an image-picking device.

5. The method accroding to claim 1 wherein said step (b) is executed by scanning a calibrating piece.

6. The method accroding to claim 1 wherein said step (b) is executed by assigning a gray scale value of 0 to said pixel when said calibrating piece is in standard black.

7. The method accroding to claim 1 wherein said step (b) is executed by assigning a gray scale value of 255 to said pixel when said calibrating piece is in standard white.

8. The method accroding to claim 1 wherein after said step (c), said method futher comprises a step of (d) generating a digital signal representative of a portion of said scanned object between said first boundary and said second boundary.

9. The method accroding to claim 8 wherein said step (d) is executed by a charge coupled device.

10. The method accroding to claim 8 wherein after said step (d), said method further comprises a step of (e) detecting a lower boundary of said object.

11. The method accroding to claim 10 wherein after said step (e), said method further comprises a step of (f) initializing said image-picking device when said lower boundary of said object is detected.
